(19) United States
(12) Patent Application Publication
(10) Pub. No.: US 2023/0222410 A1
(43) Pub. Date: Jul. 13, 2023

(54) SYSTEMS AND METHODS FOR DECOMPOSITION IN WORKFORCE OPTIMIZATION WITH SEARCH SUB-PROBLEMS

(71) Applicant: Nice Ltd., Ra’anana (IL)

(72) Inventors: Xiaoqing SUN, Flower Mound, TX (US); William Nathan STEARNS, Richardson, TX (US)

(73) Assignee: Nice Ltd., Ra’anana (IL)

(21) Appl. No.: 17/574,146

(22) Filed: Jan. 12, 2022

(51) Int. Cl. G06Q 10/06; G06Q 10/10

(52) U.S. Cl. CPC G06Q 10/063116; G06Q 10/06312; G06Q 10/109

(57) ABSTRACT

Systems and methods are provided for solving workforce management scheduling optimization decomposing and iteratively. Execution of a master problem can occur to select a best schedule among generated schedules for each employee of a group of employees while enforcing one or more global constraints. The generated schedule can be determined by execution of one or more sub-problems, each of the one or more sub-problems can be enforced work rules for the respective employee through the use of reduced cost for the employee. A flexible objective function can be executed to account for workforce management schedule wide metrics, including fitness of schedule to demand, fairness among the group of employees, schedule preferences and others.

### FIELD OF THE INVENTION

The invention relates to systems and methods for workforce management scheduling, e.g., scheduling employees in contact center operations, retail operations, branch operations, field service operations, etc. to, for example, meet service performance targets for interactions that can require different skills. More specifically, the invention can allow for scheduling employees that can have various skills, proficiencies per skill, and/or contribution factors (e.g., due to fatigue), with varying arrival patterns of interactions and/or average handling times that are time varying.

### BACKGROUND OF THE INVENTION

Workforce management systems can include processes to match resources to jobs and/or items that consume resources over time. Employee resources can be allocated over a time frame to optimize certain objectives. Many objectives and constraints can factor into optimal scheduling.

For example, staffing level targets can be set based on service level goals for different times of a week. One objective of schedule optimization can be the minimizing of deviations from target staffing levels. Other objectives of schedule optimization can include employees' work schedule preferences (such as preferred work hours) and/or schedule fairness (such as rotating weekend shifts among eligible employees). Constraints, such as union rules, government regulations, and/or employee work-life balance objectives, can also effect scheduling.

Current jobs and/or items that consume resources can require service that includes an ability to traverse multiple channels due to the propagation of social media and digital channels. Customers can be served through phone calls, chats, social media and/or e-mails. Certain interactions can require an instantaneous response, e.g., chat. Certain interactions can have a deferred response, e.g., email. Some jobs can require service in more than one language. Different types of work (such as phone calls and chats) can have different skill needs from employees.

Current workforce management systems can vary from ten to tens of thousands of employees with tens to tens of thousands of constraints.

Typical current workforce management systems typically cannot perform and/or account for all or substantially many of the optimizations and constraints. Typically, workforce management systems limit the number of optimizations and/or constraints that can be input to the system to ensure that the schedules can be produced. For example, work rule options can be limited, skill groups can be processed sequentially, employee work groups sizes can be constrained, and/or other limits are placed on the system to ensure timely completion of schedule generation. Typical current workforce management systems tradeoff flexibility and accuracy for performance because, for example, the number of combination of schedules that can be produced can run into the billions.

Therefore, it can be desirable to schedule a workforce with high optimization accuracy and flexibility in constraints, while producing a schedule in a period of time that is acceptable in the real world. It is not uncommon for current typical workforce management systems to require several hours and/or significant CPU/RAM to produce a set of schedules, whereas end users of workforce management systems actually require a set of schedules to be produced within 15 minutes.

### SUMMARY OF THE INVENTION

Advantages of the invention can include providing a workforce management system that can allow for flexibility to model different combinations of work rules with highly complex work rule constraints and employee preferences, using a myriad of skill profiles across a combination of channels, with a high degree of accuracy and efficient (e.g., fast) schedule optimization for a large number of employees (e.g., on the order of tens of thousands or more). The computational time can be reduced up to 80% compared to current practices.

In one aspect, the invention involves a decomposition and iterative computerized-method for solving workforce management scheduling optimization. The method can involve execution of a master problem to select a best schedule among generated schedules for each employee of a group of employees while enforcing one or more global constraints, wherein the generated schedule is determined by execution of one or more sub-problems, wherein each of the one or more sub-problems enforce work rules for the respective employee through the use of reduce cost for the employee. The method can also involve executing a flexible objective function to account for workforce management schedule wide metrics, including fitness of schedule to demand, fairness among the group of employees, schedule preferences and others.

In some embodiments, wherein the one or more sub-problems generate a new decision variable that determines a choice of a weekly schedule that consists of start times and stop times for an employee. In some embodiments, wherein the one or more sub-problems generate a weekly schedule given any weekly day-off patterns. In some embodiments, wherein the one or more sub-problems are executed in parallel.

In some embodiments, wherein the best schedule can be based on a single daily rule with minimum shift separation, single daily shift or split shifts, single daily rules with consistent start, single daily rule with minimum rest period, mutually exclusive weekly rules or any combination thereof.

In some embodiments, wherein the best schedule can include simultaneous optimization of break, lunch, and other unproductive activity placements. In some embodiments, wherein the best schedule includes both immediate response work streams and deferred work streams. In some embodiments, wherein the deferred work is processed before a deadline.

In some embodiments, wherein the master problem and the sub-problems are continually iterated through until convergence is met, wherein the best schedule is found when the iterations continually produce similar quality of results. In some embodiments, wherein a sequence of shifts is enforced through a sub problem schedule generation search.

In another aspect, the invention includes a non-transitory computer program product comprising instruction which, when the program is executed cause the computer to execute of a master problem to select a best schedule among generated schedules for each employee of a group of employees while enforcing one or more global constraints, wherein the generated schedule is determined by execution of one or more sub-problems, wherein each of the one or more sub-problems enforce work rules for the respective employee through the use of reduce cost for the employee. The program can also cause the computer to execute a flexible objective function to account for workforce management schedule wide metrics, including fitness of schedule to demand, fairness among the group of employees, schedule preferences and others.

In some embodiments, wherein the one or more sub-problems generate a new decision variable that determines a choice of a weekly schedule that consists of start times and stop times for an employee. In some embodiments, wherein the one or more sub-problems generate a weekly schedule given any weekly day-off patterns. In some embodiments, wherein the one or more sub-problems are executed in parallel.

In some embodiments, wherein the best schedule can be based on a single daily rule with minimum shift separation, single daily shift or split shifts, single daily rules with consistent start, single daily rule with minimum rest period, mutually exclusive weekly rules or any combination thereof.

In some embodiments, wherein the best schedule can include simultaneous optimization of break, lunch, and other unproductive activity placements. In some embodiments, wherein the best schedule includes both immediate response work streams and deferred work streams. In some embodiments, wherein the deferred work is processed before a deadline.

In some embodiments, wherein the master problem and the sub-problems are continually iterated through until convergence is met, wherein the best schedule is found when the iterations continually produce similar quality of results. In some embodiments, wherein a sequence of shifts is enforced through a sub problem schedule generation search.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is an example of a workforce management system, according to some embodiments of the invention.

FIG. 2 is a diagram of a method for schedule generation, according to some embodiments of the invention.

FIG. 3 is a graphical example of shift scoring, according to an embodiment of the invention.

FIG. 4 is a graphical example of a week-long schedule with a shift for each work day, and non-work days (days “off”) according to some embodiments of the invention.

FIG. 5 shows an example of a graphic illustration of the search algorithm for a sub problem for one daily work rule, with any weekly day-off pattern, according to some embodiment of the invention.

FIG. 6 Error! Reference source not found. shows an example of a graphic illustration of sub problem search algorithm for work rules with start time consistency as a requirement, according to some embodiments of the invention.

FIG. 7 shows a block diagram of a computing device 500 which can be used with embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

In general, a workforce management system can include workforce management schedule optimization. The workforce management schedule optimization can involve decomposing the workforce management scheduling into a master problem and a plurality of sub-problems. The plurality of sub-problems can generate candidate schedules.

The workforce management scheduling can be solved iteratively, such that the master problem can solve for an optimal schedule given the generated candidate schedules and can produce dual values for various constraints. All possible daily shifts for all employees can be scored on the concept of reduced cost using, for example, the dual values of related constraints. The sub-problems can generate weekly candidate schedules based on a concept of reduced cost using the dual values. The newly generated candidate schedules can be added to the master problem. This process can continue until convergence occurs.

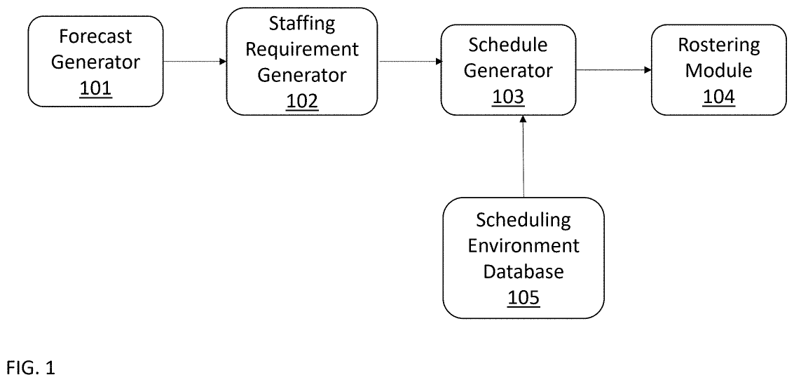

FIG. 1 is an example of a workforce management system, according to some embodiments of the invention. The workforce management system can include a forecast generator 101, a staffing requirement generator 102, a schedule generator 103, a scheduling environment database 105 and a rostering module 104.

The forecast generator 101 can generate one or more predictions on the number of interactions for a given time interval (e.g . . . 15 minutes, 30 minutes, 60 minutes) and processing times of each interaction. For example, the forecast generator 101 can predict a number of customer voice calls to occur over a particular time period (e.g., 15 minutes), over a particular time horizon (e.g. 1 week, or any defined time horizon).

The staffing requirement generator 102 can convert work volume from the forecast generator 101 into staff requirements by receiving one or more predictions for expected number of interactions and processing times. These predictions can be combined with service objectives (e.g., service level, average speed of answer, average speed of response) and other constraints to, for example, calculate the number of employees needed for each time interval across the defined time horizon.

The schedule generator 103 can receive the staffing requirements from the staffing requirement generator 102 and receive scheduling environment inputs from the scheduling environment database 105. The scheduling environment database 105 can include one or more inputs (e.g., constraints) that can effect the scheduling, as is described in further detail below. The schedule generator 103 can generate the schedule for a group of employees based on the staffing requirements and/or the one or more inputs, as is described in further detail below.

The rostering module 404 can be used by the end user to manage the schedules (e.g. make schedule updates, trade schedules, cancel schedules) that are generated by the schedule generator 103.

The forecast generator 101, the staffing requirement generator 102, the schedule generator 103, the rostering module 104 and/or the scheduling environment database 105 can be implemented on a single computing device, multiple computing devices, or any combination. For example, each of the forecast generator 101, the staffing requirement generator 102, the schedule generator 103, the rostering module 104 can be implemented on their own respective computing devices. In some embodiments, the forecast generator 101, the staffing requirement generator 102 can be implemented on one computing device, and the schedule generator 103, the rostering module 104 can be implemented on another computing device.

The computer devices that the workforce management system components can reside in are general computers and servers with general operating systems (e.g. Windows, Linux). The devices can reside on a public or private cloud service (e.g. Amazon WebServices). Each generator can be a microservice to the overall system, invoked through http/https calls. The system requirement can be a minimum of 8 GB of memory and 4 virtual or physical CPU cores.

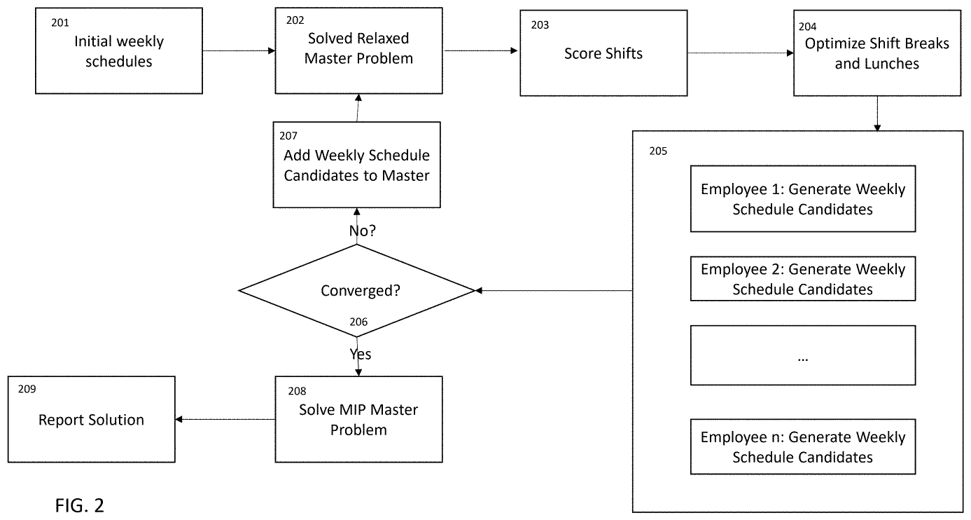

FIG. 2 is a diagram of a method for schedule generation (e.g., via the schedule generator 103 as described above in FIG. 1), according to some embodiments of the invention.

The method can involve generating initial weekly schedules (Step 201). The initial weekly schedules can be generated for one or more employees (e.g., group of employees). The group of employees can be an input (e.g., stored in scheduling environment database 105 as described above in FIG. 1). The group of employees can be one employee, ten employees, hundreds of employees, thousands of employees or any numbers of employees.

The initial weekly schedules can be randomly generated, without regard to the optimal coverage of the staffing requirements (e.g., from the Staffing Requirement Generator 102 in FIG. 1). The initial weekly schedules can be feasible schedules that may not violate work rules, but may not be required to be optimal schedules. The initial weekly schedules can serve as starting point for the schedule optimization process by providing a seed value for analyzing the distance from the optimal solution.

One or more weekly schedules, (e.g., initial weekly schedules or candidate schedules) can be generated by sub problems where all work rules (e.g. work time restrictions, shift type restrictions, day off restrictions) are explicitly enforced for each employee or group of employees. Scheduling constraints other than work rules (e.g. overall business constraints such as seat limit constraints) are enforced by the master problem (e.g.,). In some embodiments, as subset of work rules are explicitly enforced for each employee or group of employees.

The one or more decision variables can be for different purposes. In various embodiments, the one or more decision variables are intermediate to simplify formulation and/or used to derive other variables to enforce work rules and/or practical constraints.

The one or more decision variables can include each employee's choice of weekly schedule. Table 1 provides an example of an employee's choice of weekly schedule. As shown in Table 1, there are three choices for an employee. Each choice can be a decision variable. In table 1, the decision variable is 1 if the choice is selected, 0 otherwise.

TABLE 1

| Choices | Monday | Tuesday | Wednesday | Thursday | Friday | Saturday | Sunday |
|---|---|---|---|---|---|---|---|
| 1 | 10:00-19:00 | 8:00-17:00 | 12:00-21:00 | off | 8:00-17:00 | off | 8:00-17:00 |
| 2 | 10:00-19:00 | 10:00-19:00 | off | 10:00-19:00 | off | 10:00-19:00 | 10:00-19:00 |
| 3 | 10:00-19:00 | 16:00-1:00* | off | off | off | 10:00-19:00 | 10:00-19:00 |

*shift crosses midnight into next day

The constraints (e.g., work rules) can include (with appropriate notations):

I: Set of all time intervals indexed by i;

A: Group of all employees (e.g., employees) indexed by a;

Jₐ: Set of weekly candidate schedules already generated for employee a;

SK_{g}: Set of all employees in a particular skill group g. A skill group can include a set of employees who serve the same set of contact types (e.g., email, chat and/or phone). A contact type can be a specified type of interaction that has a staffing requirement. Each contact type's staffing requirement can be achieved by creating schedules for the employees in the particular skill group;

CT_{g}: Set of contact types that skill group SK_{g} can serve;

Jₐ: Set of schedule candidates for employee a that are already generated. In the first iteration the schedule candidates can be the initial schedule candidate.

xₐⱼ∈{0,1} decision variable for schedule candidate j∈Jₐ for employee a;

The one or more weekly schedules for each employee can be determined as shown in EQN. 1 below.

Σ_{j∈j}_{ₐ}xₐⱼ=1∀a EQN. 1

A full time equivalent (FTE) can be determined. The FTE can be the effective number of employees to satisfy the resource request. The FTE can be determined without consideration for whether employees are full time or part time. For example, an FTE of 2 can satisfied by scheduling 1 person full time or 2 people part time.

In some embodiments, one or more constraints are as follows:

rₜᵢ: FTE staffing requirement for contact type t at time interval i;

y_{gti}: FTE contribution of group g employees to contact type t at time interval i. A particular skill group can provide service to more than one contact type if the skill group is multi-skilled. In some embodiments, an amount of time the skill group spends on a particular contact type can be determined. The amount of time can be based on contact type staffing requirements, work distribution rules and/or prioritization, and/or skill levels. The contribution ratio can vary at each time interval.

cₐⱼᵢ: Employee a, schedule candidate j availability at time interval I, where a value of 0 is not working, a value of 1.0 is full availability, a value between 0 and 1.0 is fractionally available (e.g. discount for possible breaks or shrinkage). If an employee's availability is 1, this can indicate an employee is fully contributing to meet the staffing requirements. If an employee's availability is 0, this can indicate an employee is not contributing to meet the staffing requirements. If an employee's available is between 0 and 1.0 (e.g. fractionally available), this can indicate a partial availability of the employee (e.g., due to other restrictions).

The FTE contribution constraints can be determined as shown below in EQN. 2

$${\sum }_{a ∈ {SK}_{ℊ}} {\sum }_{j ∈ {J}_{a}} {x}_{aj} {c}_{aji} - {\sum }_{t ∈ {CT}_{ℊ}} {y}_{ℊ ti} = 0 ∀ i , ℊ \qquad EQN . 2$$

In some embodiments, each time interval can have an over amount of staffing scheduled or an under amount of staffing scheduled. The under coverage and the over coverage can be described as follows:

uₜᵢ: Under coverage for contact t and at time interval i; and

oₜᵢ: Over coverage for contact t and time interval i.

Contacts can be deferrable and non-deferrable. Deferrable contacts can be contacts that can wait to be answered (e.g. an email). Non-deferrable contacts can be contacts that cannot wait to be answered to, for example, avoid the contact perceiving a substantial delay (e.g., a chat).

Constraints for non-deferrable contacts can be determined as shown below in EQN. 3:

$${\sum }_{ℊ} {y}_{ℊ ti} - {o}_{ti} + {u}_{ti} - {r}_{ti} = 0 ∀ t , i \qquad EQN . 3$$

where rₜᵢ is defined in paragraph [0048].

Constraints for deferrable contacts to dₜ future time interval can be determined as shown below in EQN. 4 and EQN. 5:

$${\sum }_{ℊ} {y}_{ℊ ti} - {l}_{ti - 1} + {l}_{ti} - {r}_{ti} - {o}_{ti} + {u}_{ti} = 0 ∀ t , i \qquad EQN . 4$$

$${l}_{ti} - {\sum }_{k = i - {d}_{t}}^{i} {r}_{tk} \leq 0 ∀ i , t \qquad EQN . 5$$

Where lₜᵢ is left over from time interval i for contact type t. For a time interval when further left over is not permissible (e.g., operating hours end at 4 pm every day), lₜᵢ can be delayed or set to zero.

In some embodiments, location and/or seat capacity can influence the schedule. The location and/or seat capacity can be described as follows:

wₐⱼᵢ=1 if weekly schedule candidate i of employee a uses a seat at time interval i, 0 otherwise.

l is an employee group of which employees share seats. L is set of the employee groups sₗᵢ^{upper}, sₗᵢ^{lower} are upper and lower seat limits for employee group l∈L at time interval i.

The location and/or seat capacity constraints can be determined as shown below in EQN. 6:

sₗᵢ^{lower}≤Σ_{a∈l}xₐⱼwₐⱼᵢ≤sₗᵢ^{upper}∀l∈L,i EQN. 6

In some embodiments, schedule fairness can influence the schedule. Assume fairness rotation Q_{w} as employee queue for fairness rotation w, d_{w} as the day or days that Q_{w} is for. Q_{w} can be viewed as an ordered list of employees. For fairness day or days, if there is a need for an employee or employees to work on the day or days, the employee in front of the list needs to work on the day or days first before the employees after him/her. Let a₀ be the first employee in the queue and aₘ₊₁ be the employee right after employee aₘ in the queue. Let X_{d}_{_{w}}ₐa be the set of schedule candidates of employee a that contain days in d_{w}.

The constraint of schedule fairness can be determined as shown below in EQN. 7:

$${\sum }_{{j}_{{a}_{m + 1}} ∈ {X}_{{d}_{{wa}_{m + 1}}}} {x}_{{a}_{m + 1} {j}_{{a}_{m + 1}}} \leq {\sum }_{{j}_{{a}_{m}} ∈ {X}_{{d}_{{w}^{a} m}}} {x}_{{a}_{m} {j}_{{a}_{m}}} + {f}_{{a}_{m}}^{w} ∀ m , {d}_{w} \qquad EQN . 7$$

Where fₐ_{ₘ}^{w} is fairness violation indicator. It is 1 when fairness is violated. X_{d}_{_{w}}ₐ_{ₘ} is a set of schedule candidates of m+1 position employee of fairness queue w aₘ that have fairness day or days as work day or days.

In some embodiments, the constraint of schedule fairness can include weekend fairness. In some embodiments, if the weekend fairness rule is not “both days”, X_{d}_{_{w}}ₐ is defined as a weekly schedule that contains either Saturday or Sunday. In some embodiments, if the weekend fairness rule is “both days”, then X_{d}_{_{w}}ₐ is both days.

The method can also involve executing a master problem (Step 202). Executing the master problem can involve executing the master problem to select a best schedule among generated schedules for each employee of the group of employees while, for example, enforcing all global constraints. The master problem can have initial weekly schedules as input from Step 201 the first time it executes. In some embodiments, the master problem can be executed iteratively. In these embodiments, each subsequent execution, the mater problem can have one or more schedule candidates for each employee as input.

In some embodiments, pₐⱼ can be a measure for fitness of a weekly schedule) to an employee's preferred weekly schedule). Preferences can include preferences of day-offs (e.g., weekend is preferred), desirability of break placement, pay differentials and/or total work hours.

In some embodiments, the master problem can be determined via an objective function. The objective function can be determined as shown below in EQN. 8:

Let POₜᵢ and PUₜᵢ be the penalty factors for solving for under coverage and over coverage

$$min {\sum }_{t , i} ( {u}_{ti} {PU}_{ti} + {o}_{ti} {PO}_{ti} ) + {\sum }_{a , j} {p}_{aj} {x}_{aj} + {\sum }_{w} {\sum }_{{a}_{m}} {p}_{f} {f}_{{a}_{m}}^{w} \qquad EQN . 8$$

where aₘ is defined in paragraph [0055]

Linear penalty with respect to under and over coverage is not preferred, therefore the objective function can be easily modified to penalize more for bigger over or under coverage.

The method can also involve determining a score for shifts (work schedules) (Step 203 in FIG. 2). The Score Shifts process can be a measure of how well the master problem solution met the staffing requirements. The Score Shifts can be determined by Column Generation. Column Generation can include generating additional schedules that can have the potential to improve the schedules generated by the master problem.

The additional schedules can be generated via a reduced cost as a measure to evaluate the potential of a schedule to improve the overall solution. There can be two components in reduced cost. The first one can be coefficient entering the objective function, pₐⱼ in equation Error! Reference source not found. 8. The second one is dual values of constraints that a variable inserts. The reduced cost can have the following form: c−Σ(a×d), objective function coefficient, coefficient into various constraints, and/or dual values of corresponding constraints or rows. Based on this, the reduced cost associated with each weekly schedule can have four levels of components: weekly schedule level; day level; shift level; and time interval level.

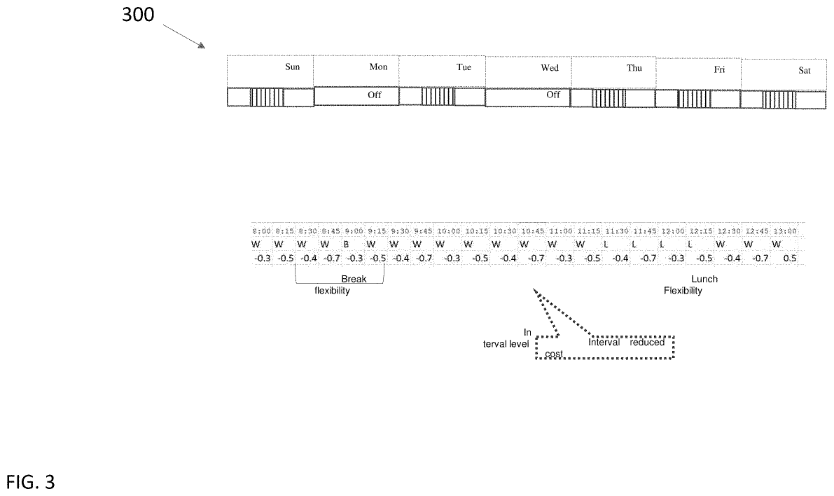

For example, FIG. 3 is a graphical example of reduced costs at different levels according to some embodiments of the invention. FIG. 3 shows a weekly schedule 300, where Monday and Wednesday are days off. If, for example, Monday off is not a preferred day off for the employee, then there can be a penalty imposed in the score. This is a day level reduced cost.

Preferences for shifts at a particular time of day can result in certain shifts with added incentive. This added incentive can be reduced cost at the shift level.

Constraints (e.g., as described above in EQN1.) states that only s one schedule can be selected for each employee. The dual values of this type of constraints can be at the weekly schedule level.

In some embodiments, the reduced cost is at a time interval level. For example, if total time worked or pay differential is part of the objective function, each working time interval can be contributing to it.

Turning back to FIG. 2, the FTE contribution constraints can be defined for every time interval and every skill group. The seat limits are defined for every time interval and every physical location that has seat limit. The dual values of those constraints can contribute to the reduced costs at time interval levels.

Scoring a shift can include aggregating all reduced costs defined at shift and time interval levels. In some embodiments, scoring a shift can include accounting for preference for desired break and/or lunch placements. For time intervals in breaks and lunches, the reduced cost from the FTE contribution constraints typically do not contribute or do not contribute significantly to the shift reduced cost. The day level reduced cost can be added to all shifts' reduced cost of the day.

The inputs to scoring a shift include all possible shift candidates for all employees and dual values of various constraints related to the master problem that are related to a shift. The output can include a score for each shift, wherein the score is based on reduced cost.

The method can also involve optimizing shift breaks and/or lunches (Step 204). Scheduling breaks and/or lunch for some time intervals can include excluding the schedule from entering those constraints, which can result in a change of reduced cost. In some embodiments, breaks and/or lunches are chosen to minimize a weekly schedule's reduced cost. The input to optimizing shift breaks and/or lunches can include shift candidates, dual values of FTE contribution constraints and/or seat limit constraints. The output is optimal timing of lunches and breaks for each shift candidates.

There can be one sub problem for each employee (Step 205). The sub-problems can generate one or more new schedules for each employee of a group of employees. As shown in FIG. 2, Employee 1 can have a weekly schedule generated, Employee 2 can have a weekly schedule generated, . . . Employee n can have a weekly schedule generated, where n is a integer value and the number of employees. The one or more new schedules can be used by the master problem to select the best schedule.

Work rules can be complicated and can vary from country to country, region to region, company to company, location to location, and/or even within the same company. Work rules can be considered in the one or more sub-problems. Having a single algorithm that works for all combination of work rules can be impractical due to processing limitations. For example, computers can crash from attempting to process to large of a volume of data and/or take an amount of time that is outside of a duration that a workforce management system operates within. The sub-problems can allow for parallel processing and for each employee or group of employees to have their respective schedule generated in parallel or substantially in parallel while accommodating uniqueness of their respective work rules.

Each employee can have an associated sub-problem that can be responsible for generating a weekly schedule candidate for the employee. The employee specific sub-problems can be independent of one another, allowing, for example, parallel processing. The input to a sub-problem can be one or more scored shifts, and one or more inter shift preference scores. For example, if it is preferred to have an afternoon shift followed by a day off, an incentive can be provided to incentivize such a combination from a group of afternoon shifts to a day-off next day. (One or more work rules such as minimum shift separation (e.g., minimum number of hours between the end a shift to the beginning of next shift), one or more day-off patterns and/or one or more minimum weekly rest period are described herein later.) The output can be one weekly schedule candidate for each employee that has potential to improve the overall solution. The potential is decided by each weekly schedule's negative reduced cost.

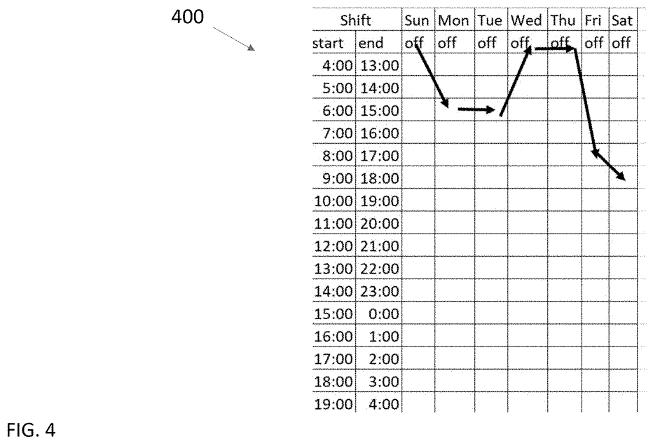

FIG. 4 is a graphical example of a week-long schedule with possible shifts for each work day, according to some embodiments of the invention. The week-long schedule 400 includes shift start and stop times, and the days off. The list is feasible with respect to all the work rules. FIG. 4 shows the week long schedule with minimum negative reduced cost.

Turning back to FIG. 2, the one or more subproblems can be determined by determining a shortest path.

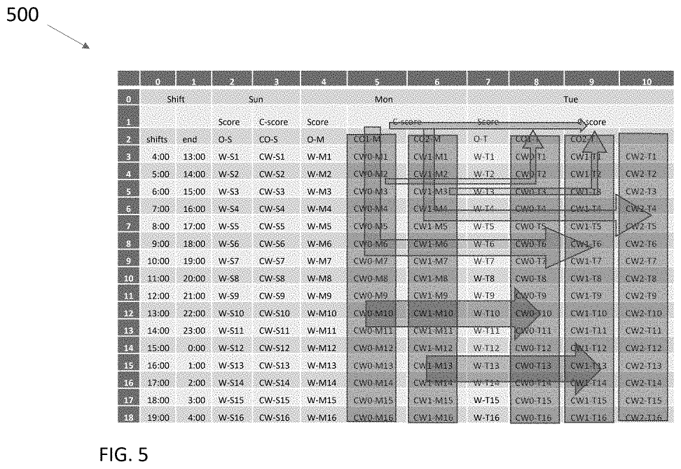

The one or more sub-problems can be determined by finding a shortest path while enforcing the work rules. FIG. 5 shows an example of a graph for a set of work rules, according to an embodiment of the invention. FIG. 5 shows an example for the first 3 days. The work rules for FIG. 5 can be as follows:

Daily rule: Each shift has a flexible start time in a range from 4:00 to 19:00 with increment of 60 minutes, and shift duration of 9 hours;

Weekly rules: The daily rule can be used for any day of a week. There are min and max two days off, that can be take on any two days of the week.

There is a minimum separation of 10 hours between shifts.

For Monday:
Cell [2;4] (row 2 and column 4) is shift score (O-M) when taking the day off for Monday.
Cell [2;7] is shift score (O-T) when taking Tuesday off.
Cells [2;4 . . . 5] (row 2 and columns 4 to 5) are best cumulative scores for one day off (CO1-M) and two day off (CO2-M) when Monday is off. We label cumulative scores when Monday is off with the number of day-offs to make sure that our search guarantees the best weekly schedule.
Cells [3 . . . 18;4] and [3 . . . 18;7] are shift scores when for Monday and Tuesday when they are work days.
For a given workday, there are several columns of cumulative scores. For example, there are 3 columns of cumulative scores for working Tuesday with prefixes of CW (cumulative workday); and CW1-T15 stands for cumulative score for workday when there is only 1 off for Tuesday (15 is a shift sequence number).

The search that updates subsequent nodes for Monday to Tuesday is shown in FIG. 5. The arrows provide directional links from a node or a block of node to a node or a block of nodes.
Updating from a day-off cumulative node to a day-off cumulative node. For example, CO1-M to CO2-T can be used. CO2-T=min {CO1-M+O-T, CO2-T).
Updating from a block of cumulative workday nodes to a day-off cumulative node. For example, use cells [3 . . . 18,6] to CO2-T. Let min CW1-M be the minimum value of cells [3 . . . 18,6]. CO2-T=min {minCW1-M+O-T, CO2-T).
Updating from a day-off cumulative node to a block of cumulative workday nodes. For example, use CO1-M to cells [3 . . . 18,9]. Each cell in [3 . . . 18,7] can be updated. For example, [15,9]. The cumulative score in cell [15,9] is CW1-T13 which is for the Tuesday shift that starts at 16:00 and has a shift score of W-T13 (cell [15,7]). CW1-T13=min{CO1-M+W-T13, CW1-T13},
Updating from a first workday block of cells to a second workday block of cells. For example, [3 . . . 18,6] to cells [3 . . . 18,9]. The updating can involve:
   1. Sorting originating cells by end time (e.g., ascending. [3 . . . 18,6] is already sorted by end time in this example).
   2. Set originating cells to [3 . . . 18,6].
   3. Set destination cells to [3 . . . 18,9].
   4. Find the minimum value of originating cells, minValue,
   5. If the cell is outside of cells [3 . . . 8,6], update all feasible cells in destination cells and reduce the destination cells to the cells that have not been updated.
      Remove cells that has the minValue and cells after it from originating cells
      Go to step 4.
   6. If the cell of the minimum value is within cells [3 . . . 8,6], all destination cells are feasible determined by minimum shift separation of 10 hours. Update all destination cells like:
      CW1-T13=min{CW1−T13, minValue+W-T13}
      Updating is complete.

As is apparent to one of ordinary skill in the art, the procedure described above can work for various minimum day-offs and max number of day-offs, where minimum day-offs and max number of day-offs can be integer values.

In various embodiments, an employee can vary a number of workdays with a same amount of hours works. For example, an employee can take a 4 day work week or 5 day work week with total number of weekly hours being the same. For example, an employee who must work 40 hours per week can work 4 days of 10-hour day or 5 days of 8-hour day. For this example, the weekly rule can rely upon two daily rules that are mutually exclusive, and both include a minimum separation between shift of 10 hours. The weekly rule states that the employee receives 2 days off if one rule is used and 3 days if the other daily rule is used.

Daily rule 1: 10-hour workday with starting time range.

Daily rule 2: 8-hour workday with a starting time range.

Solution: Generate a shift for rule 1 and generate a shift for rule 2 using the process described above in Step 205. Both shifts can be added to the master problem if they have negative reduced costs.

In various embodiments, a group of employees can be scheduled consistently with some flexibility. For example, all starting times of workdays must be within a band of 45 minutes.

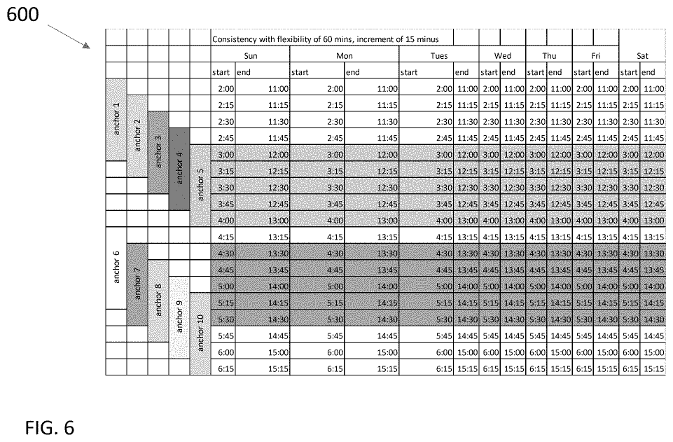

FIG. 6 Error! Reference source not found. shows an example of a graphical illustration of work rules 600 with consistency requirement, according to some embodiments of the invention. For each start time, consistency anchors can be created. For example, Anchor 5 includes shifts of start times of 3:00, 3:15, 3:30, 3:45, and 4:00.

Create nodes for each day and each anchor, create a node with a score being the best score of all shifts included in the anchor for that day.

Find best days to work for each anchor, that meet work rules. For example, if weekly day-off pattern is any 2 days off, we sort nodes of different days and choose best 5 nodes that correspond to 5 days to work. Find the best anchor among all anchors. Find the best shift for each day given the best anchor.

Turning back to FIG. 2, determining the sub-problems can involve determining irregular day off patterns. In some embodiments, for a minimum number of day-offs and maximum number of day-offs and day-off can be taken on any days of the week, regular day-off patterns can be determined. In some embodiments, day off patters do not have to be regular. For example, an employee can have 2 or 3 day-offs in a week where the 2 day-offs are consecutive.

Turning back to FIG. 5, there are 3 columns cells [3 . . . 18;8 . . . 10]. The cumulative score for column 8 can be denoted with a prefix of CW0 (cumulative, workday, 0 day-off), CW1 (1 day-off) for column 9, and CW2 (2 day-off) for column 10. The cumulative scores are typically only comparable if searches have the same number of day-offs. It can be sufficient for regular day-off patterns. Leading day-off patterns to Tuesday (including Tuesday) 101 and 011 with 1 day off can have the same future day-off patterns.

In the above example, the 3 columns correspond to 3 distinct future (Wednesday, Thursday, Friday, and Saturday) day-off patterns. Table 2 shows an example of a weekly day off pattern grouping.

TABLE 2

| Weekly | | | | |
|---|---|---|---|---|
| Pattern # | Sun | Mon | Tue | Wed |
| 0 | 0 | 0 | 0 | 1 |
| 1 | 0 | 0 | 1 | 1 |
| 2 | 1 | 0 | 0 | 1 |
| 3 | 0 | 1 | 1 | 1 |
| 4 | 1 | 0 | 1 | 1 |
| 5 | 1 | 1 | 0 | 1 |

As shown in Table 2, there is a total 6 day-off patterns for the first four days of a week that lead to a workday for Wednesday and 3 groups, {0}, 11,21, and {3,4,5}. Each group can have a corresponding column similar to the 3 columns of work Tuesday in FIG. 5. Each pattern within each group has the same future day-off patterns for Thursday, Friday, and Saturday. For example Group {3,4,5} has future day-off patterns 001,100; group 11,21 has future day-off patterns 011,101,110.

The preceding process can work for any day of a week and any day-off patterns that is provided.

Turning back to FIG. 2, the one or more sub-problems can involve determining a minimum rest period. The minimum rest period can require that there has to be one separation between the end of one shift and the start of the next that meet a minimum of certain hours, e.g., 35. If work rules allow flexible start, a day-off does may not guarantee the separation. In some embodiments, to ensure this requirement is met, the search can cross multiple days as shown, for example, in FIG. 4. As shown in FIG. 4, in a weekly day-off pattern, an employee can have any two days off in a week, such that the search can distinguish if the minimum rest period has been met and that it has not been met yet. Cumulative scores on Sunday can be used to update Monday's cumulative scores, Tuesday's cumulative scores if Monday is off, and Wednesday's if both Monday and Tuesday are off.

Step 206 determines if the optimization process has converged If the number of schedules determined by the one or more sub-problems is below a predetermined threshold, then it can be determined that convergence has occurred. The predetermined threshold can be based on experience and the size of the problem. The predetermined threshold can be input by a user.

In some embodiments, if the objective function value difference between last two iterations is below a predetermined threshold, then it can be determined that convergence has occurred.

If the process did not converge, the method can also involve adding weekly schedule candidates to master problem (Step 207), and returning to Step 202. The schedules created by the one or more sub-problems can be the input to the mater problem.

If the process did converge, the method can also involve solving the MIP master problem by, for example, converting it to an MIP problem (Step 208) and can involve reporting the solution (Step 209). The master problem can be determined as described in Step 202.

The one or more employee schedules can be transmitted to a display.

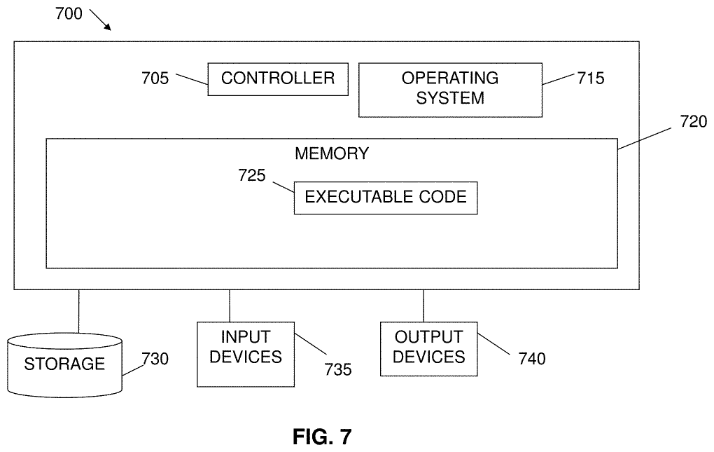

FIG. 7 shows a block diagram of a computing device 700 which can be used with embodiments of the invention. Computing device 700 can include a controller or processor 705 that can be or include, for example, one or more central processing unit processor(s) (CPU), one or more Graphics Processing Unit(s) (GPU or GPGPU), a chip or any suitable computing or computational device, an operating system 715, a memory 720, a storage 730, input devices 735 and output devices 740.

Operating system 715 can be or can include any code segment designed and/or configured to perform tasks involving coordination, scheduling, arbitration, supervising, controlling or otherwise managing operation of computing device 700, for example, scheduling execution of programs. Memory 750 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 720 can be or can include a plurality of, possibly different memory units. Memory 720 can store for example, instructions to carry out a method (e.g. code 725), and/or data such as user responses, interruptions, etc.

Executable code 725 can be any executable code, e.g., an application, a program, a process, task or script. Executable code 725 can be executed by controller 705 possibly under control of operating system 515. For example, executable code 725 can when executed cause masking of personally identifiable information (PII), according to embodiments of the invention. In some embodiments, more than one computing device 700 or components of device 700 can be used for multiple functions described herein. For the various modules and functions described herein, one or more computing devices 700 or components of computing device 700 can be used. Devices that include components similar or different to those included in computing device 700 can be used, and can be connected to a network and used as a system. One or more processor(s) 705 can be configured to carry out embodiments of the invention by for example executing software or code. Storage 730 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 730 and can be loaded from storage 730 into a memory 720 where it can be processed by controller 705. In some embodiments, some of the components shown in FIG. 7 can be omitted.

Input devices 735 can be or can include for example a mouse, a keyboard, a touch screen or pad or any suitable input device. It will be recognized that any suitable number of input devices can be operatively connected to computing device 700 as shown by block 735. Output devices 740 can include one or more displays, speakers and/or any other suitable output devices. It will be recognized that any suitable number of output devices can be operatively connected to computing device 700 as shown by block 740. Any applicable input/output (I/O) devices can be connected to computing device 700, for example, a wired or wireless network interface card (NIC), a modem, printer or facsimile machine, a universal serial bus (USB) device or external hard drive can be included in input devices 735 and/or output devices 740.

Embodiments of the invention can include one or more article(s) (e.g. memory 720 or storage 730) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A decomposition and iterative computerized-method for solving workforce management scheduling optimization, the method comprising:
execution of a master problem to select a best schedule among generated schedules for each employee of a group of employees while enforcing one or more global constraints,
wherein the generated schedule is determined by execution of one or more sub-problems,
wherein each of the one or more sub-problems enforce work rules for the respective employee through the use of reduce cost for the employee; and
executing a flexible objective function to account for workforce management schedule wide metrics, including fitness of schedule to demand, fairness among the group of employees, schedule preferences and others.

2. The method of claim 1 wherein the one or more sub-problems generate a new decision variable that determines a choice of a weekly schedule that consists of start times and stop times for an employee.

3. The method of claim 1 wherein the one or more sub-problems generate a weekly schedule given any weekly day-off patterns.

4. The method of claim 1 wherein the one or more sub-problems are executed in parallel.

5. The method of claim 1 wherein the best schedule can be based on a single daily rule with minimum shift separation, single daily shift or split shifts, single daily rules with consistent start, single daily rule with minimum rest period, mutually exclusive weekly rules or any combination thereof.

6. The method of claim 1 wherein the best schedule can include simultaneous optimization of break, lunch, and other unproductive activity placements.

7. The method of claim 1 wherein the best schedule includes both immediate response work streams and deferred work streams.

8. The method of claim 7 wherein the deferred work is processed before a deadline.

9. The method of claim 1 wherein the master problem and the sub-problems are continually iterated through until convergence is met, wherein the best schedule is found when the iterations continually produce similar quality of results.

10. The method of claim 1 wherein a sequence of shifts is enforced through a sub problem schedule generation search.

11. A non-transitory computer program product comprising instruction which, when the program is executed cause the computer to:
execute of a master problem to select a best schedule among generated schedules for each employee of a group of employees while enforcing one or more global constraints,
wherein the generated schedule is determined by execution of one or more sub-problems,
wherein each of the one or more sub-problems enforce work rules for the respective employee through the use of reduce cost for the employee; and
execute a flexible objective function to account for workforce management schedule wide metrics, including fitness of schedule to demand, fairness among the group of employees, schedule preferences and others.

12. The non-transitory computer program product of claim 11 wherein the one or more sub-problems generate a new decision variable that determines a choice of a weekly schedule that consists of start times and stop times for an employee.

13. The non-transitory computer program product of claim 11 wherein the one or more sub-problems generate a weekly schedule given any weekly day-off patterns.

14. The non-transitory computer program product of claim 11 wherein the one or more sub-problems are executed in parallel.

15. The non-transitory computer program product of claim 11 wherein the best schedule can be based on a single daily rule with minimum shift separation, single daily shift or split shifts, single daily rules with consistent start, single daily rule with minimum rest period, mutually exclusive weekly rules or any combination thereof.

16. The non-transitory computer program product of claim 11 wherein the best schedule can include simultaneous optimization of break, lunch, and other unproductive activity placements.

17. The non-transitory computer program product of claim 11 wherein the best schedule includes both immediate response work streams and deferred work streams.

18. The non-transitory computer program product of claim 17 wherein the deferred work is processed before a deadline.

19. The non-transitory computer program product of claim 11 wherein the master problem and the sub-problems are continually iterated through until convergence is met, wherein the best schedule is found when the iterations continually produce similar quality of results.

20. The non-transitory computer program product of claim 11 wherein a sequence of shifts is enforced through a sub problem schedule generation search.
